(19) United States
(12) Patent Application Publication
(10) Pub. No.: US 2025/0020564 A1
(43) Pub. Date: Jan. 16, 2025

(54) Method and Apparatus for Determining Liquid-Solid Adhesion Work

(71) Applicant: HUN-REN Energiatudományi Kutatóközpont, Budapest (HU)

(72) Inventor: Norbert Nagy, Budapest (HU)

(21) Appl. No.: 18/713,368

(22) PCT Filed: Nov. 23, 2022
(86) PCT No.: PCT/HU2022/050083

§ 371 Date: May 24, 2024

(30) Foreign Application Priority Data
Nov. 24, 2021 (HU) P2100405

(51) Int. Cl. G01N 13/02

(52) U.S. Cl. CPC G01N 13/02; G01N 2013/0208

(57) ABSTRACT

The invention is a method for determining liquid-solid adhesion work, during which, in connection with a liquid cylindrically symmetric capillary bridge in fluid medium between an end portion having peripheral circular edge of a measurement element and a solid surface-to-be-tested
by performing cylindrical symmetry-keeping modification on the capillary bridge
   determining (S110a) changes of interfacial areas of the capillary bridge and fluid medium, and of the capillary bridge and surface-to-be-tested, and
   by determining (S100) capillary force, determining (S110b) a total mechanical work corresponding thereto,
determining (S120), for the cylindrical symmetry-keeping modification, based on the interfacial area changes, total mechanical work and liquid-fluid interfacial tension a difference value of the solid-liquid and solid-fluid interfacial tensions, and by subtracting that from the liquid-fluid interfacial tension, determining (S130) the liquid-solid adhesion work.

The invention is, furthermore, an apparatus for determining liquid-solid adhesion work. (FIG. 1)

### TECHNICAL FIELD

The invention relates to a method and apparatus adapted for determining liquid-solid adhesion work.

### BACKGROUND ART

Liquid-solid adhesion work is a quantity that is generally used for characterising liquid-solid interfaces; its value provides information on the interaction of the solid and liquid phases being in contact on a unit surface area. It is therefore a specific quantity, its measurement unit being identical to that of surface tension (Nm/m2); it is, however denoted by the letter “W” customarily denoting work, but the specific work could also be denoted by lowercase “w”. It is of outstanding importance in all such industrial fields where a liquid is in contact with a solid surface (e.g., electronics and cosmetics, paper, adhesive, paint, print and textile industries, soldering and dental technology etc.). This quantity is determined in an indirect way, by the help of the Young-Dupré equation, by measuring the contact angle formed at the liquid-solid phase boundary:

$${W}_{a} = {γ}_{LF} \cdot ( 1 + cos {ϑ}_{Y} ) \qquad ( 1 )$$

where Wₐ is the liquid-solid adhesion work, γ_{LF} is the interfacial tension (boundary surface tension) of the liquid and the fluid medium, ϑ_{Y} is the equilibrium (Young) contact angle formed at the liquid-solid-fluid medium triple-phase boundary.

This method bears in itself various measurement and theoretical uncertainties stemming from the characteristics of the contact angle measurement methods. In certain cases, the value of the contact angle can be determined with significant uncertainty, especially in the case of small) (<10°-20° and large) (>150° contact angles. Furthermore, the equilibrium Young contact angle ϑ_{Y} cannot be measured; in practice, the advancing contact angle is determined after the advancing of the contact line, in a stationary state thereof, while the receding contact angle can be measured in the stationary state after the receding of the contact line. According to some works, ϑ_{Y} can be calculated from these two values [A. Marmur: Solid-Surface Characterization by Wetting. Annu. Rev. Mater. Res. 39, p. 473-89 (2009)]. A further problem is posed by the fact that on certain surfaces the receding contact angle is not constant, i.e., it decreases with the volume of the sessile drop [e.g., J. Drelich et al.: The Effect of Drop (Bubble) Size on Advancing and Receding Contact Angles for Heterogeneous and Rough Solid Surfaces as Observed with Sessile-Drop and Captive-Bubble Techniques. J. Colloid Interface Sci. 179, p. 37-50 (1996)]. Furthermore, in a number of cases the value of the adhesion work determined from the measured contact angle significantly deviates from the calculated or otherwise determined values (e.g. in R. Tadmor et al. Solid-Liquid Work of Adhesion. Langmuir 33, p. 3594-3600 (2017)).

An apparatus and method are known wherein the force required for eliminating the solid-liquid interface under specific geometric conditions and with specific parameters is measured in order to characterise liquid-solid adhesion (document JP 2011191277 A). The water contact angle of hydrophobic and superhydrophobic surfaces can typically be determined with large error, so an apparatus (document EP 3571483 A1) was developed which, by the help of a circular plate fixed to a force measurer and utilising it to press a liquid droplet against the surface, measures the forces occurring during bringing the droplet closer (approximating) and taking it further (distancing it) from the surface, including the time instances of forming and eliminating the solid-liquid interface. A similar apparatus and method are disclosed in JP 2004144573 A, wherein the adhesion force originating in a liquid volume arranged between solid surfaces is measured during the process of taking the solid surfaces further and bringing them closer to each other (i.e., the capillary force, which in certain disclosures is termed “adhesion force”, see also the description below related to these terms).

In DE 102012221490 B3 a method is disclosed wherein bodies having certain parameters are submerged into a liquid and certain quantities are deduced based on this.

An apparatus and a method suitable for measuring dynamic contact angles is disclosed in JP 2013174478 A. This approach does not apply a force measurer. A similar technical approach is disclosed in CA 2968623.

In JP 2001116675 A an apparatus and a method for measuring contact angles and dynamic surface tension are disclosed.

An apparatus adapted for determining contact angles is disclosed in the professional article N. Nagy: Contact Angle Determination on Hydrophilic and Superhydrophilic Surfaces by Using r-θ-Type Capillary Bridges [Langmuir 35, p. 5202 (2019)]. The professional article addresses aspects related to contact angles.

An apparatus that is similar to the apparatus described in the professional article is disclosed in the above-mentioned EP 3571483 A1.

In U.S. Pat. No. 6,537,499 B1, the identification of molecules situated on a surface leads back to force measurement. In the course of this the base surface of an elastic column having a known surface area is pressed directly against the tested surface comprising the molecules. The force applied in the course of the compression is directed at deforming the elastic column, the work invested being stored by the column in the form of elastic energy. In the method according to the document, the adhesion work between the molecules and the surface with a known area is identified as the difference between the integral (over the displacement) of the forces measured when compressing and pulling apart the surfaces, as a quantity characteristic of the molecules.

An approach for determining adhesion work without measuring the contact angle is disclosed in US 2011118993 A1. This approach is fundamentally different from the above approaches, it is based on rotational (centrifugal) measurement, and on the fact that at the moment the droplet becomes detached from the surface, the force exerted on the droplet can be calculated from the rotational speed.

In view of the known approaches, there is a need for an apparatus and method for determining liquid-solid adhesion work that allow for determining liquid-solid adhesion work more efficiently compared to existing approaches.

### DESCRIPTION OF THE INVENTION

The primary object of the invention is to provide a method and apparatus for determining liquid-solid adhesion work, which are free of the disadvantages of prior art approaches to the greatest possible extent.

The object of the invention is to provide a method and apparatus by means of the application of which the liquid-solid adhesion work can be determined independent of the contact angle measured at the liquid-solid interface (surface), i.e., the task to be solved that was set for the invention was determining the liquid-solid adhesion work independently of measuring the contact angle.

The objects of the invention can be achieved by providing the method according to claim 1 and the apparatus according to claim 4. Preferred embodiments of the invention are defined in the dependent claims.

The method and the apparatus according to the invention are based on the recognition that, in case a cylindrically symmetric (cylindrical-symmetric) capillary bridge extending between a circular-shaped solid surface and the tested solid surface is formed from the liquid in the fluid medium that surrounds them such that the contact line of the liquid adheres (pins) to the edges of the circular-shaped solid surface, while the capillary force is measured in (the) course of a cylindrical symmetry-keeping modification (a cylindrical symmetry-keeping change) of the capillary bridge (i.e., length or volume change thereof), while determining the change of the liquid-fluid interfacial area (liquid-fluid interfacial area change) and the change of the interfacial area of the liquid and the tested solid surface (liquid-tested solid surface interfacial area change) in the course of the process, then, by integrating the capillary force, the energy change of the system, thus in the knowledge of the liquid-fluid interfacial tension the solid-liquid adhesion work can be determined.

### BRIEF DESCRIPTION OF THE DRAWINGS

Preferred embodiments of the invention are described below by way of example with reference to the following drawings, where

FIG. 1 is a flow diagram of the method according to the invention,

FIG. 2 is a schematic drawing of an apparatus suitable for carrying out an embodiment of the method according to the invention,

FIG. 3 is a schematic drawing of an apparatus suitable for carrying out another embodiment of the method according to the invention, and

FIGS. 4A and 4B show graphs illustrating measurements performed on hydrophilic and hydrophobic surfaces to be tested.

### MODES FOR CARRYING OUT THE INVENTION

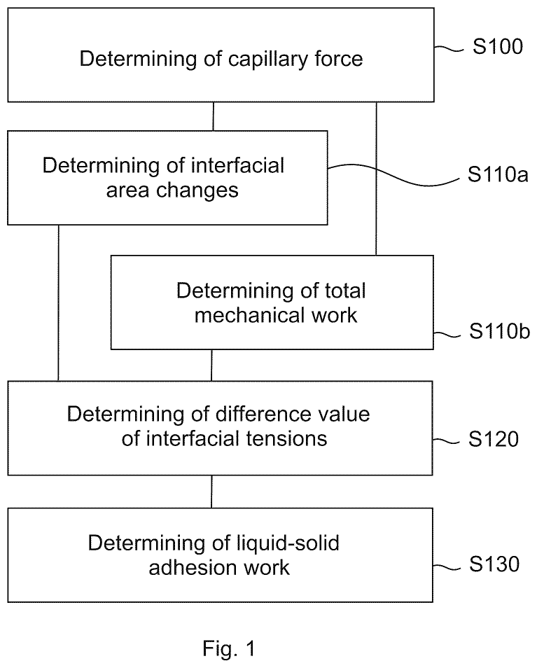

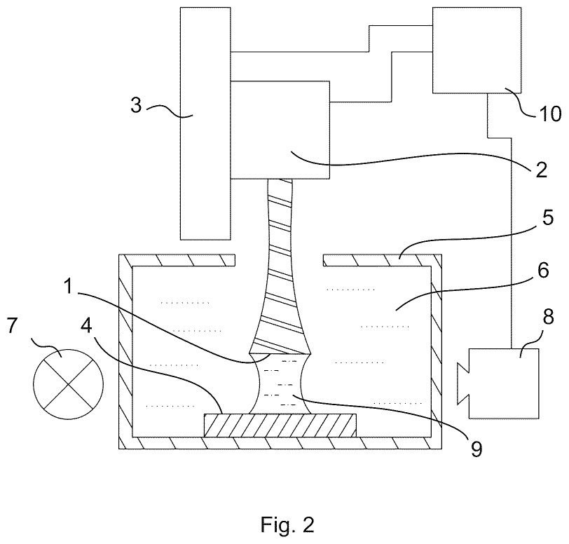

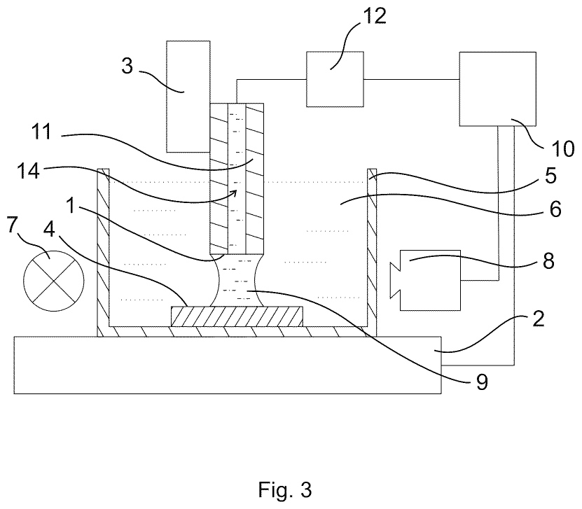

The invention is a method for determining liquid-solid adhesion work (in relation to the method according to the invention, reference is made to FIG. 1 showing the flow diagram of the method, and to FIGS. 2 and 3 that illustrate apparatuses adapted for carrying out the method according to the invention), in the course of which, in connection with a liquid cylindrically symmetric capillary bridge (cylindrically symmetric capillary bridge (being) of liquid) formed in a fluid medium between an end portion having peripheral circular edge of a measurement element (an end portion of a measurement element which end portion has peripheral circular edge) and a surface to be tested of a solid object to be tested, the steps given below are performed (see a fluid medium 6, a surface 4 to be tested and a capillary bridge 9 in FIGS. 2 and 3). The (necessarily solid) surface to be tested (to-be-tested) of the solid object to be tested (to be investigated) is—emphasizing that in the method, application of a solid surface is necessary—concisely termed in the description as a “tested solid surface” (see the description of FIGS. 2 and 3).

Forming the capillary bridge is not considered to be a part of the method according to the invention. This is in accordance with the fact that the method is based on measurements themselves taken on the capillary bridge, i.e., the capillary bridge is maintained during the whole course of the method. It could be also done that forming of the capillary bridge—when the capillary bridge is formed by approximating (moving closer) a droplet situated typically on or transferred to the end portion of the measurement element having peripheral circular edge to the surface to be tested (or transferring it there directly)—is treated a separate step.

Furthermore, by requiring the cylindrical symmetry of the capillary bridge according to the above it is preferably also determined that the circular edge of the end portion having peripheral circular edge is perpendicular to the longitudinal axis of the measurement element (which is here also the movement axis of that, i.e. the symmetry axis corresponding to the cylindrical symmetry) in the course of the method, because thereby the cylindrical symmetry of the bridge can be brought about.

A cylindrically symmetric capillary bridge is formed thanks to the end portion having peripheral circular edge (peripheral circular rim), adhering on (to, onto) its edge. At the same time, by requiring cylindrical symmetry, it is also required of the surface to be tested that it does not break this cylindrical symmetry, i.e., that it is preferably a plane arranged parallel to the end portion having peripheral circular edge, or an appropriately arranged spherical surface (see further below). In the latter case, due to the cylindrical symmetry there is a dedicated arrangement of the object to be tested with respect to the end portion facing the measurement element (other such surfaces are also conceivable). The surface to be tested is generally arranged in a cylindrical symmetry keeping manner.

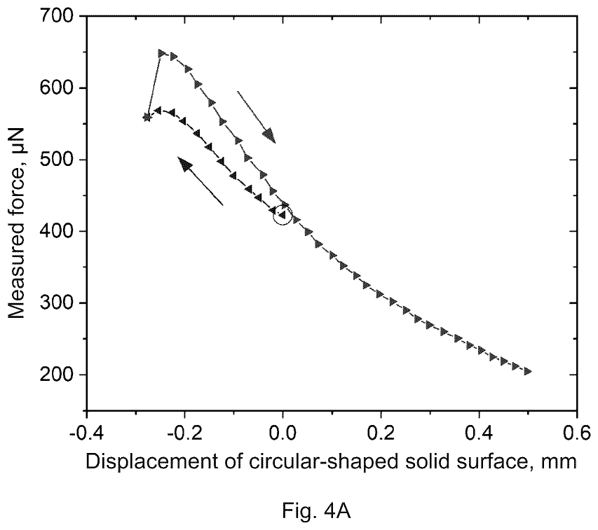

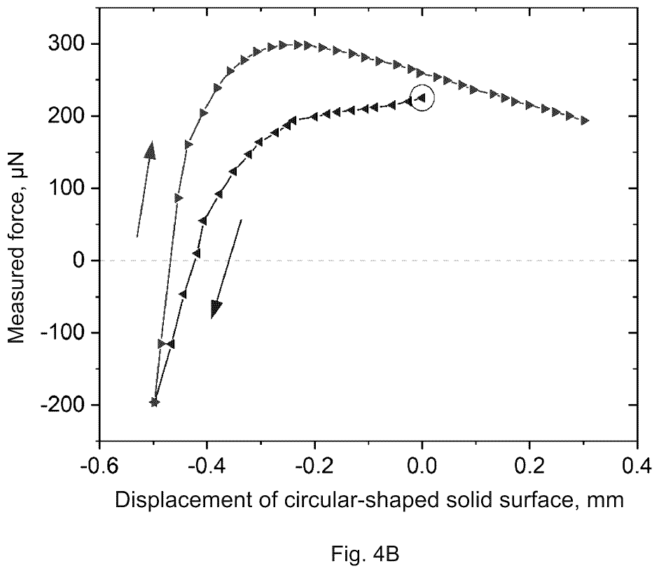

In the course of the method according to the invention ((the description of) the steps of the method according to the invention starts in this paragraph) by performing a cylindrical symmetry-keeping modification on the cylindrically symmetric capillary bridge, starting (started) from an initial state and ending (ended) in a final state, (as suggested by their names, the initial state and the final state are naturally the states between which the method is carried out, i.e. measurements are performed on the capillary bridge as needed for each of the measurements; in relation to the specific quantities see also the formulas below)
between the initial state and the end state a first interfacial area change (a first surface area change) of a first interfacial area (a first boundary surface area) of the capillary bridge and the fluid medium, and a second interfacial area change (a second surface area change) of a second interfacial area (a second boundary surface area) of the capillary bridge and the surface to be tested are determined (operational step S110a related to determining interfacial area changes corresponds to this; that is, the first interface is the interface between the liquid—the capillary bridge—and the fluid, the change of it is the first interfacial area change, and the second interface is the interface between the capillary bridge and the surface to be tested—i.e., the surface where the capillary bridge contacts (touches) the surface to be tested, see FIGS. 2 and 3—the change of it is the second interfacial area change), and
by determining in the course of the cylindrical symmetry-keeping modification at least one displacement value of the working-related displacement (work-doing displacement, working displacement, displacement corresponding to work done) corresponding to the cylindrical symmetry-keeping modification and respective force value of the capillary force corresponding to the capillary bridge therefor (about determining the displacement value see below; determining of the force value is a determining by a measurement, it can also be termed that it is determined based on a measurement; operational step S100 related to determining the capillary force corresponds to that; see also FIGS. 4A-4B in connection with the graphs (running) of the recorded values, and the aspects related to the range investigated by the method), based on the at least one displacement value determined in the course of the cylindrical symmetry-keeping modification and the force value assigned respectively thereto, a total mechanical work corresponding to the capillary force is determined for the cylindrical symmetry-keeping modification (operational step S110b related to determining the total mechanical work corresponds to this).

It is phrased above that “at least one displacement value of the working-related displacement corresponding to the cylindrical symmetry-keeping modification”. This is taken to mean that a total working-related displacement corresponds to the modification, and the values thereof are determined—in measurement time instances (time points)—(is measured as a whole or divided into parts), i.e., the displacement value is determined (e.g. measured) typically at a plurality of points, and respective force values corresponding to this plurality of points are also determined. The total working-related displacement is obtained as the sum of the one or more displacement values; these displacement values are measured (generally: are determined) in the course of the cylindrical symmetry-keeping modification.

If a single displacement value is recorded (i.e., the entire working-related displacement corresponding to the cylindrical symmetry-keeping modification is treated as a single unit), then the force values are also measured typically at both endpoints thereof (i.e., in the initial and final states; it is thus permitted to determine more than one (normally, two) force values for a single displacement value). If at least two displacement values are determined, then a respective capillary force value is determined for each of them, and the total mechanical work is determined based on the displacement values and the respective force value assigned to each.

According to the above, the work is determined based on one or typically more displacement values and respective force value assigned to it or to each of them. For the discrete displacement values (because of the typical cases, a plural form is used in many cases, but there may only be a single such value) typically recorded in the course of the measurement and the respective force values assigned to them the total mechanical work can be determined by summation (cf. FIGS. 4A-4B showing the force values determined for the respective displacement values; however, the specific force value assigned to a given displacement is a matter of choice, see below: it can be a force value measured at any of both end points of the given displacement value, or for example the average of them, i.e., a force value derived from the measured force values). In this case, the total mechanical work is determined by summing up a product of the displacement value (occurring between consecutive measurement time instances) and the respective force value corresponding to each of the displacement values.

Also, based on the displacement values and the force values assigned to them the points of the displacement-force function can be recorded, and the total mechanical work can even be determined by integrating the function fitted to the points (summation is essentially a numerical integration in the case of sufficiently small displacement values), i.e., the total mechanical work is preferably determined by summation, numerical integration, or integration.

As illustrated also by the figures, the direction of the displacement is parallel to the direction of the capillary force (both are signed quantities), so the work can be calculated as a product thereof in the formula (2).

A capillary force corresponds to the capillary bridge, i.e., in accordance with the principle of capillarity, the capillary bridge exerts this force on the surfaces that it connects. In connection with this, reference is made to the exemplary measurements disclosed in FIGS. 4A-4B for which the evolution of force values is detailed. In relation to the working-related displacement corresponding to the cylindrical symmetry-keeping modification—in other words, the working-related displacement assigned to the capillary force—reference is made to the description of FIGS. 2 and 3, wherein it is specified which displacement is assigned to the capillary force (a displacement of the end portion of the measurement element, a displacement of liquid inside the capillary conduction channel), with which—for example by summation—the total mechanical work can be calculated, i.e., the mechanical work corresponding to the entire cylindrical symmetry-keeping modification (this term is correct also because the gravitational effects are neglected; it can also be called capillary force work, or even simply first work).

By performing the method, in the preferred dimension range of the capillary bridge the weight of the capillary bridge is typically negligible beside the force originating from the interfacial tension of the liquid and the fluid medium and the force originating from the curvature of the interface (boundary surface) between the liquid and the fluid medium (the sum of these two forces is the capillary force). Therefore, also the gravitational force is negligible, and can be omitted from the formulas.

There is no hierarchy between the steps according to the two points above, i.e. the order of them here does not imply an execution order. Because the force is measured during the entire course of the cylindrical symmetry-keeping modification (or a modification keeping cylindrical symmetry; it could also be termed a modification maintaining or preserving cylindrical symmetry), this can be interpreted as being earlier than the determination of the total mechanical work from the recorded force values and of the interfacial area changes, however, the latter two steps can also be performed in any order or even simultaneously, as indicated also by their reference numerals.

It is also noted that determining the interfacial area change is such a measurement step that is preferably performed by taking optical recordings and utilising them for calculating interfacial areas at the given time instances and their difference between the initial state and the final state.

In connection with the summation for the cylindrical symmetry-keeping modification, reference is made to the description of formula (2). In the extreme case (limit case, border case), summation becomes integration—as it is reflected in the designations in formula (2)—, however, as it is illustrated in FIGS. 4A-4B, due to the discrete nature of the measurements, low but finite displacement values are applied for the calculation. The force values are to be summed up with the displacement values over the given (entire, i.e., applied for the method on the capillary bridge) cylindrical symmetry-keeping modification (i.e., the for the entire investigated process that was selected during the recording of measurement data between the initial and final states) in order to determine the total mechanical work (the total mechanical work thus obtained is called being corresponding to the capillary force as a consequence of that it is calculated by summing up as well as integrating the latter with the displacement: see the term ∫F dz of the formula (2) below).

Furthermore, in the course of the method according to the invention (in this paragraph, further steps of the method according to the invention are given) based on the first interfacial area change, the second interfacial area change, the total mechanical work, and a liquid-fluid interfacial tension (a liquid-fluid boundary surface tension) of the (liquid) capillary bridge and the fluid medium, a first difference value of (between)
a solid-liquid interfacial tension (a solid-liquid boundary surface tension) of the surface to be tested and the (liquid) capillary bridge and
a solid-fluid interfacial tension (a solid-fluid boundary surface tension) of the surface to be tested against the fluid medium,
   is determined for the cylindrical symmetry-keeping modification (operational step S120 related to determining the interfacial difference value corresponds to this), and by subtracting the first difference value from the liquid-fluid interfacial tension, a liquid-solid adhesion work corresponding to the cylindrical symmetry-keeping modification and being characteristic of the (liquid) capillary bridge and (of) the surface to be tested is determined (operational step S130 related to determining the liquid-solid adhesion work corresponds to this).

The essence of the method and apparatus according to the invention is that a cylindrically symmetric capillary bridge is formed between a circular-shaped solid surface and the tested solid surface from the liquid in the fluid medium that surrounds these. The liquid wets the circular-shaped solid surface well, the meniscus of the liquid adheres (pins) on the edge of the circular-shaped solid surface.

The end portion of the measurement element is referred to at the above introduction of the method as an end portion having peripheral circular edge (the circle line shaped edge extends along the periphery thereof; expediently it is and edge of a preferably flat end portion of a cylindrical element). In accordance with the cylindrically symmetric configuration of the capillary bridge, this has also a cylindrically symmetric configuration. In this description, the illustrated implementation of this is called a “circular-shaped (solid) surface”, and it is shown in the figures as having flat configuration (accordingly, the end portion having peripheral circular edge can preferably also have a flat configuration, while it has naturally solid configuration).

In the configuration of FIG. 2, the circular-shaped surface is a (naturally flat) circular plate (situated) at the bottom of the measurement element, while in the configuration of FIG. 3, a channel 14 of the capillary tube 11 opens to the circular-shaped surface, accordingly, the end portion can be of a planar (flat) circular ring shape or a planar (flat) ring shape with a circular outer periphery, the inner periphery of which is different from a circle, for example, square or rectangular.

Also, in accordance with the previous identification, the liquid wets well the circular-shaped solid surface, so the meniscus of the liquid adheres (pins) on the edge (rim) of the circular-shaped solid surface, i.e., the interfacial area of the end portion having peripheral circular edge and the capillary bridge can be considered to be constant. Preferably, a surface of appropriate material facilitating appropriate wetting can be applied at the end portion (e.g., glass or platinum); also, the presence of the edge ensures permanency of the interfacial area between the end portion and the capillary bridge, as it is not preferable to let the liquid detach therefrom (i.e., contact line adhesion provides help). This is independent of that the object to be tested (test object) is hydrophilic or hydrophobic.

With reference to the figures, performing the method is described according to two kinds of embodiments. Firstly, reference is made to the performing according to FIG. 2. In this case, the distance between the two solid surfaces is changed such that the direction of the relative displacement coincides with the axis of symmetry of the capillary bridge (i.e., a cylindrical symmetry-keeping modification is applied, that is, a modification that does not spoil the cylindrical symmetry of the capillary bridge). By changing the distance between the solid surfaces, the length of the capillary bridge is changed. When the two solid surfaces are brought closer to each other, the capillary bridge becomes shorter, while upon distancing them from each other the length of the capillary bridge increases. In the case of both processes the size of the liquid-fluid interfacial area changes, as well as the size of the interfacial area of the liquid and the tested solid surface also being changed. The interfacial area between the liquid and the circular-shaped solid surface does not change because the meniscus of the liquid adheres (pins) on the edge of the circular-shaped solid surface.

The capillary force and the relative displacement of the solid surfaces are measured in the course of the process. Integrating the measured force according to the displacement gives the work (i.e., the work done on or by the system), which work is spent for changing the sizes of the interfacial areas (in connection with the formulas, reference is made to the illustrative measurement results shown in FIGS. 4A-4B).

$$\int F dz = Δ A \cdot {γ}_{LF} + Δ B \cdot ( {γ}_{SL} - {γ}_{SF} ) \qquad ( 2 )$$

where F is the capillary force, dz is the relative displacement (working-related displacement) in the course of the approximating (approaching) or distancing (retracting) movement, ΔA is the change of the size of the liquid-solid interfacial area, γ_{LF} is the liquid-fluid interfacial tension (this is similarly a Greek gamma like in the formula), ΔB is the change of the size of the interfacial area of the liquid and the tested solid surface, γ_{SL} is the interfacial tension of the liquid and the tested solid surface, and γ_{SF} is the interfacial tension of the tested solid surface and the fluid medium.

When approximating and distancing the solid surfaces (to and from each other), determining the change of the sizes of the interfacial areas at the start as well as at the end point, the expression (γ_{SL}−γ_{SF}) can thus be calculated. This remains the only parameter to be calculated in the equation, because the value of the integral on the left of (2) is determined, like the interfacial area changes. In the experiments, the unknown parameters (unknowns) are the parameters of the surface to be tested, i.e., also the interfacial tensions corresponding thereto; however, the liquid-fluid interfacial tension γ_{LF} is considered as known. The above-detailed process of calculating the liquid-solid adhesion work is also in line with this.

By harmonizing the notation of the formula also with the terminologies (concepts) introduced above, the first difference value (see above) is calculated according to (expressed by rearranging equation (2)):

$${γ}_{SL} - {γ}_{SF} = \frac{\int F dz - Δ A \cdot {γ}_{LF}}{Δ B} \qquad ( 3 )$$

formula (for the sign convention in connection with the force for applying the formula, see further below), wherein
γ_{SL} is the solid-liquid interfacial tension, and γ_{SF} is the solid-fluid interfacial tension,
∫F dz is the total mechanical work,
γ_{LF} is the liquid-fluid interfacial tension, and
ΔA is the first interfacial area change, and ΔB is the second interfacial area change.

The liquid-solid adhesion work (Wₐ) is defined as (as it was mentioned in the introduction, in contrast to the quantities in (2), this is a specific quantity):

$${W}_{a} = {γ}_{LF} - ( {γ}_{SL} - {γ}_{SF} ) \qquad ( 4 )$$

and therefore, in the knowledge of the liquid-fluid interfacial energy (γ_{LF}) the liquid-solid adhesion work can be calculated.

The above slightly modifies in case the method is carried out according to another embodiment. In relation to that, reference is made to FIG. 3. In this case, the circular-shaped solid surface is a cross section (end portion) of a capillary tube, and, instead of changing the distance between solid surfaces, the volume of the capillary bridge formed from liquid can be changed. Thus, in this case the distance between the solid surfaces is kept constant, but the volume change dV of the capillary bridge is measured. Increase and decrease of the volume correspond, respectively, to bringing the solid surfaces closer and taking them further from each other. In this case, in order to calculate the work, the capillary force have to be integrated over the relative displacement of the liquid column in the capillary tube (working-related displacement), i.e., the quantity ‘dV/a’, where ‘a’ is the inside cross-sectional area of the capillary tube. All other is essentially the same with the description above.

If (according to the convention applied often) the attractive capillary force is regarded to have a positive sign (in other words: considering the capillary force to have positive sign in the attractive case), in accordance with equations (2) and (4) above, a quotient of the difference between the mechanically performed work and the work required for changing the liquid-fluid interfacial area, and the liquid-solid interfacial area change is to be subtracted from the liquid-fluid interfacial tension to obtain the liquid-solid adhesion work.

The liquid-solid adhesion work can also be determined in case we deviate from this convention and consider the attractive capillary force to have a negative sign. In such a case, a quotient of the difference between the negative of the mechanically performed work and the work required for changing the liquid-fluid interfacial area, and the liquid-solid interfacial area change would have to be subtracted from the liquid-fluid interfacial tension to obtain the liquid-solid adhesion work. Therefore, if another sign convention would be used, it would cause the integral on the left of (2) to reverse sign (also having an effect on formula (3), wherein the integral would be included with a negative sign). Accordingly, the exact procedure of calculation depends on the chosen sign convention; however, it is possible to determine the liquid-solid adhesion work on the basis of the quantities determined in a manner described above.

The adhesion work determined during the advancing of the contact line of the liquid formed on the solid surface is characteristic of the driving force behind the spreading of the liquid, while the adhesion work determined in the receding situation is a quantity that characterises the “liquid retention” of the surface (i.e., how difficult it is to detach the liquid from the surface). The mechanical work invested when the contact line is stationary is only utilised for changing the liquid-fluid interfacial area, i.e., with a stationary (non-moving) contact line no information can be obtained on the liquid-solid adhesion work.

In accordance with the above, the present invention is based on the recognition that the work done on the system (or by the system) is spent on changing the liquid-fluid (medium) and the liquid-solid interfacial areas, and thereby the liquid-solid adhesion work can be determined in the knowledge of the mechanical work, the liquid-fluid interfacial tension, and the change of the sizes of interfacial areas.

Accordingly, the present invention has the fundamentally novel element (aspect) not following from the past, that the liquid-solid adhesion work can be determined separately and in absolute manner beside advancing and receding of the contact line of the capillary bridge from the mechanical work and the change of the interfacial areas for each of the advancing and the receding situations.

In the following, the manner of measuring or determining the quantities applied in the method for determining liquid-solid adhesion work will be described. In relation with this, reference is also made to the description of FIGS. 2 and 3.

The capillary force can be measured if the circular-shaped solid surface is connected to a force measurer (a force gauge), or the solid object having the tested surface (object to be tested) is arranged on a force measurer (a weighing scale).

The change of the interfacial areas and of the volume of the capillary bridge can be determined by taking side-view images of the capillary bridge formed by the liquid when the solid surfaces are being brought closer to each other and also when they are being distanced from each other, as well as when the volume is increased and decreased, at least at start and at the endpoint.

The size of the interfacial area of the liquid and the tested solid surface can be calculated—because the capillary bridge is cylindrically symmetric—by determining in the image the distance between the contact points of the generatrices of the capillary bridge and the tested solid surface (i.e., the diameter of the circular-shaped contact line of the liquid), provided that the geometry of the tested solid surface is known (in relation to calculations based on camera images reference is made to the professional article mentioned above in the introduction by N. Nagy, “Contact Angle Determination on Hydrophilic and Superhydrophilic Surfaces by Using r-θ-Type Capillary Bridges” [Langmuir 35, p. 5202 (2019)]. If, for example, the tested solid surface is a flat surface, the interface in question is a circular plate. If, for example, the tested solid surface is a spherical surface (with the topmost or bottommost point coinciding with the axis of symmetry of the capillary bridge), the interface is the surface of a spherical cap.

The requirement set forth above for the cylindrical symmetry of the capillary bridge, and the other above-mentioned condition (i.e., that the direction of the relative displacement coincides with the axis of symmetry of the capillary bridge) support that the modification made to the capillary bridge keeps (preserves) the cylindrical symmetry. Applying a linear motor for displacing also facilitates this. The case of volume change is analogous to this, because image analysis can also be applied in that case, and there are no such circumstances—volume is changed via the channel of the capillary tube—that could cause a change breaking the cylindrical symmetry.

The size of the liquid-solid interfacial area can be determined by performing image analysis of the shape of the capillary bridge. The size of the interfacial area can be calculated by an analytic mathematical description of the shape of the capillary bridge or can be determined by approximating the generatrix (contour) of the capillary bridge by a suitable function (e.g., a polynom), and calculating (integrating) the size of the surface of revolution obtained by rotating this curve about the axis of symmetry of the capillary bridge. According to another, slightly different solution, the generatrix of the cylindrically symmetric capillary bridge is broken down into discrete components, i.e., the surface of revolution is broken down into low-height cylinder mantles and calculating the size of the surface of revolution as the sum of these (numerical integration).

The change of the volume of the capillary bridge—for the embodiment based on that—can be determined by means of an apparatus providing the volume change (see also in relation to FIG. 3 below). The volume can also be determined by performing image analysis of the shape of the capillary bridge. The volume of the capillary bridge can be calculated by providing an analytic mathematical description of its shape, or, like with determining the liquid-fluid interfacial area, by calculating the volume of the body of revolution obtained by rotating the curve of the function fitted on the generatrix of the capillary bridge, or by numerical integration of the profile of the capillary bridge.

The change of the distance between the solid surfaces (for the respective embodiments), i.e., the length change of the capillary bridge, can be determined by means of the mechanics (mechanical arrangement) providing the linear movement, or by analysing the images taken of the capillary bridge.

During the solid bodies are brought closer to each other, as well as during the volume of the capillary bridge is increased, the contact line of the liquid formed on the tested solid surface is advancing. Therefore, the liquid-solid adhesion work determined in this way is characteristic of the spreading of the liquid on the tested surface, i.e., it corresponds to the case wherein the advancing contact angle of the liquid measured on the tested surface is substituted (inserted) into the Young-Dupré equation (see equation (1) above). When the solid bodies are brought further apart, as well as when the volume of the capillary bridge is decreased, the contact line of the liquid is receding. Therefore, the liquid-solid adhesion work determined in this way is characteristic of detaching the liquid from the tested surface, i.e., it corresponds to the case wherein the receding contact angle of the liquid measured on the tested surface is inserted into the Young-Dupré equation.

By using the Young-Dupré equation (i.e. with equation (1) above), from the value of the liquid-solid adhesion work determined in this way the (typical) values of the—advancing and receding-contact angles of the liquid formed on the tested surface can be determined by calculation, i.e., without directly measuring them. This is preferable for example in such cases wherein the uncertainty of the contact angle measurement greatly decreases the accuracy of subsequent calculations. In this respect, the manner of determining liquid-solid adhesion work according to the invention is considered to be more efficiently compared to the known approaches.

In the following FIGS. 2 and 3 will be described, illustrating the details of carrying out the corresponding embodiments of the method, and, in relation to carrying out the method, certain details of the apparatuses illustrated in FIGS. 2 and 3 (also describing options, and in many cases giving illustration on example level—which information can be generalised by analogy (as appropriate)).

In FIG. 2, an embodiment of the method according to the invention is illustrated by the help of a schematic drawing of the corresponding apparatus. In the preferred exemplary embodiment of the invention shown in FIG. 2, the circular-shaped solid surface 1 (in accordance with the figure, this reference numeral (sign) could also denote the end portion having peripheral circular edge) could for example be the base of a glass cylinder having a diameter of 2 mm (as well as, as shown in FIG. 2, it can be implemented as another such object—slightly slimmed at the middle—that has an appropriately configured end portion, i.e., a circular-shaped solid surface), or a platinum disc with a diameter identical with this. A drop (droplet) of the liquid with a volume >1 μL hangs from this surface. The upper end of the glass cylinder is connected to a force-compensated force measurer 2 having for example a resolution of ≤5 μN (components with identical functions, such as the force measurer, are denoted with same reference numerals in FIGS. 2 and 3, but the slightly different configuration at one of the variants—at e.g. this variant—can for example be indicated by an upper comma (′); such components can also be for example the circular-shaped solid surface 1 and the sample chamber 5). The movement of this in the vertical direction is provided by a linear mover (actuator) 3 having a lead (worm) screw driven by a stepper motor, with an available minimum drive speed of <0.02 mm/s.

The tested solid surface 4 is arranged under the base plate of the glass cylinder, parallel with its plane, preferably on a support adapted to move in a plane along two directions (on an x-y mover; after the capillary bridge has been formed, it is not used any more in the course of the method according to the invention). The bottom end of the glass cylinder and the tested solid surface 4 are preferably arranged in a common sample chamber 5, the fluid filling the sample chamber 5 (i.e., the fluid medium 6 surrounding the capillary bridge 9) being for example the near-saturated (≥80%) vapour space of the liquid (if a gas-phase fluid medium is applied, it is of course feasible to seal the sample chamber in such a manner—i.e., in an incomplete manner—that the end portion of the measurement element protrudes into the chamber through a small opening formed in the upper plate of the sample chamber). The term “sample chamber” is used because the sample to be tested, i.e., the solid object to be tested, is arranged therein, but it could also be called a “measurement chamber”, because the measurements are focused on it, or on the components (end portion having peripheral circular edge, capillary bridge, solid object to be tested) arranged in it.

The capillary bridge—the components applied for forming it—are not necessarily arranged in a sample chamber, i.e., they can even be arranged in free air; the measurement principle, the way of determining the liquid-solid adhesion work is not affected by that what kind of fluid medium surrounds the capillary bridge. Of course, it can be preferable to apply an appropriate fluid medium in a sample chamber (i.e., if the circular-shaped solid surface 1, the tested solid surface 4, and the capillary bridge 9 are arranged in a common sample chamber 5).

The fluid medium can therefore be preferably in a sample chamber; the solid object to be tested that has the surface to be tested in the course of the test is arranged in the fluid medium arranged in this manner, and the end portion of the measurement element having peripheral circular edge is also placed here. Preferably, the apparatus may comprise the sample chamber, i.e., it can be a fixedly arranged component thereof (with the object to be tested being replaced if necessary), but it can also be arranged only for the time period of carrying out the measurement (the method), i.e., the object to be tested can be replaced together with it.

Preferably, a light source 7 providing homogeneous illumination—in our case, for example, a LED light with a diffusor—is arranged on one side of the glass cylinder, perpendicular to the axis thereof, while on the other side opposite to it a camera 8 with a resolution of at least 1024×768 pixels, for example a CMOS (Complementary Metal-Oxide Semiconductor) camera 8 is arranged (preferably, also more than one cameras may be applied, or we could also say that at least one camera is applied because that way the cylindrically symmetric body can be better investigated). The data of the force measurer 2, the linear mover 3 and the camera 8 are preferably processed by the integrator unit 10 (summation unit or, for short, integrator), which according to FIG. 2 preferably have respective interconnections to the integrator unit 10.

In the course of the measurement process, the liquid droplet hanging from the circular-shaped solid surface 1 is first brought closer to the tested solid surface 4. As soon as the liquid droplet has reached the tested solid surface 4, i.e., from the time instance (point of time) of forming of the capillary bridge 9, the velocity of the movement is set for example to 0.0025 mm/s, and the force measured by the force measurer 2, the displacement of the circular-shaped solid surface 1, and an image taken of the capillary bridge 9 are recorded (noted) for example every 10 seconds. In the course of the approximating (approaching) process, the length of the capillary bridge 9 decreases, while the diameter of the interfacial area between it and the tested surface 4 increases.

At a time instance selected based on the geometric circumstances of the capillary bridge 9 approximating is stopped, and we start to move the circular-shaped solid surface 1 away (to distance the circular solid surface 1) applying the same parameters, this is carried on e.g. until the capillary bridge 9 ruptures (a cylindrical symmetry-keeping modification to the capillary bridge by means of approximating and distancing).

During evaluation, the second measurement point after the formation of the capillary bridge 9 is considered as the starting point of the approximation process (initial state), while the turning point is considered as the end point thereof (final state; cf. FIGS. 4A-4B: the encircled point is the point of formation, so the starting point is the second (or also counting the encircled point, the third) point of the graph; end point: in the case of FIG. 4A it is of course the point before the “jump”—at the bottom in the figure—at the turn). The starting point (initial state) of the distancing phase, for example, the second measurement point after the turning point is considered, while as the end point thereof (final state) the measurement point is considered at which the length of the capillary bridge 9 does just not exceed the length of bridge at the time of its formation.

Thereby effectively a rule of thumb is given for determining the adhesion work by calculating separately approximating (approaching) and distancing (retracting) phases (as it is also mentioned elsewhere, the adhesion work calculated for the approximation and distancing phases are characteristic of the spreading and the detachment of the liquid, respectively).

Immediately after its formation the liquid-solid contact line is not necessarily advancing, so it is safer to investigate the process from the second point. In the case of distancing, it is also expedient to start from the second point, with a practical guidance being also given: it is not expedient to exceed the formation length, because in this phase the contact line has typically already stopped receding, while there is also a risk of rupturing the capillary bridge. It is worthwhile to apply the method for the section (part) wherein the contact line is truly in motion, for which the rule of thumb gives good support.

Therefore, the above should be treated as a rule of thumb only, i.e., departure may be made from it, as appropriate, even applying the formulas for a much shorter period. Of course, the measurement error is also larger if the investigated range of change is shorter. The rule of thumb defines long measurement periods for both the advancing and receding of the capillary bridge.

It can be appreciated that it is not worthwhile to choose a too short measurement period (between the initial and final states), i.e., to investigate a too small cylindrical symmetry-keeping modification in the method according to the invention. For example, a change between two adjacent measurement points can be regarded as too small (with a high expected measurement error), but it can still be applied in the invention. Investigating three successive measurement points in the course of the cylindrical symmetry-keeping modification will presumably yield results with less error, i.e., it may be preferable to record at least three measurement points (that is, to work with at least three measurement time instances covered by the cylindrical symmetry-keeping modification).

In the following, the determination of the liquid-solid adhesion work is performed according to the description above. The capillary force measured by the force measurer 2 is integrated by the integrator unit 10 over (according to) the relative displacement of the circular-shaped solid surface 1 measured by the linear mover 3. The liquid-fluid interfacial area is calculated (integrated) also by the integrator unit 10 based on the image recorded by the camera 8.

In another preferred embodiment of the apparatus according to the invention, shown in FIG. 3, the sample chamber 5 is arranged on the force measurer 2, in this case on an analytical (weighing) scale with a resolution ≤0.05 mg. The fluid medium 6 being in the sample chamber 5 is a liquid-state medium that is immiscible with the liquid forming the capillary bridge 9.

In case a liquid-state fluid medium immiscible with the liquid is applied, the fluid medium can be filled into the chamber in any one of the following two preferred subcases, wherein the liquid-state fluid medium 6 immiscible with the liquid is filled into the sample chamber 5:
after the capillary bridge 9 has been formed, or
in such a state of the capillary bridge 9 wherein it is the shortest or has the greatest volume.

For example, in the latter case the method is applied only in the receding case. In general, it can be noted that in many cases it is not expedient to perform the investigation in both directions (advancing, receding), but this is not necessary.

The circular-shaped solid surface 1 (generally, and end portion having peripheral circular edge, or, in accordance with the description, a circular-shaped solid surface with the channel of the capillary tube opening to it) is for example the cross section of a glass capillary tube 11 with an outside diameter of 2 mm, the capillary tube being connected to a liquid feeder 12 (liquid dispenser) apparatus preferably via a flexible tube, practically to a syringe pump having a minimal feeding rate (speed) of <0.2 μL/min, i.e. it is able to feed liquid at a rate lower than <0.2 μL/min. Linear moving of the capillary tube 11 is preferably provided by a linear mover 3 described above in relation to the embodiment illustrated in FIG. 2.

The arrangement and features of the light source 7 and the camera 8 are identical to what was described above in relation to the embodiment illustrated in FIG. 2. The data of the force measurer 2, the liquid feeder 12 and the camera 8 are processed by the integrator unit 10.

Before the measurement, the circular-shaped solid surface 1 is moved near the tested solid surface 4 so that the distance between them to be preferably ≤2 mm. A known amount of liquid is discharged (squeezed) from the capillary tube 11 until the formation of the capillary bridge 9. At this point, the measurement can be carried out as a part of the method in a manner set forth above in relation to the previous preferred embodiment, i.e., by approximating and distancing the circular-shaped solid surface 1 (thus applying the cylindrical symmetry-keeping modification). In this case the measurement is evaluated in a manner identical to the above (in this case the capillary tube 11 can be preferably descended near the tested solid surface 4 utilising the linear mover 3, as well as thereafter it can be moved in order to change the length of the capillary bridge).

This preferred embodiment also enables a different measurement process. In this case, preferably, the distance between the circular-shaped solid surface 1 and the tested solid surface 4 is not changed in the course of carrying out the corresponding embodiment of the method according to the invention. The liquid feeder 12 (e.g. syringe pump) is applied for increasing and then decreasing the volume of the capillary bridge 9 with a known quantity, for example at a rate (speed) of 0.001 μL/s (applying the cylindrical symmetry-keeping modification by volume change). During the measurement, like with the previous measurements, the force measured by the force measurer 2, the volume change of the capillary bridge 9, and an image of the capillary bridge 9 taken by the camera 8 are recorded (noted) in every 10 s. Interconnections from (the direction of) the force measurer 2, the camera 8, and the liquid feeder 12 (and preferably also the linear mover 3) to the integrator unit 10 are established also in this case.

In the course of evaluation, preferably in this embodiment the second measurement point after the formation of the capillary bridge 9 is regarded as the starting point of the volume increase, while the turning point is considered the end point thereof. Also, the starting point of the volume decrease is considered to be preferably the second measurement point after the turning point, and the end point thereof is the measurement point at which the volume of the capillary bridge 9 does just not exceed the volume measured at the time of its formation.

In the following, the liquid-solid adhesion work is determined according to the description above, with the difference that the force measured in the course of the processes is integrated by means of the integrator unit 10 over the displacement of the liquid column inside the capillary tube (dV/a) instead of integrating it over the relative displacement of the solid surfaces (as these will be kept stationary).

In this case, the linear mover 3 is therefore applied for moving to an appropriate distance from the tested solid surface 4, and thereafter it is kept stationary (at an unchanged distance from the tested solid surface 4). However, in this latter embodiment the apparatus can also be configured without applying a (linear) mover, instead fixing the capillary tube at a predetermined distance (i.e., it is fixedly arranged at this distance) from the tested solid surface 4 and the apparatus is applied this way. The liquid necessary for forming the capillary bridge can be introduced through the capillary tube also in this case.

As it was partly touched upon above, in certain cases it may be preferred to fill the liquid-state fluid medium 6 immiscible with the liquid forming the capillary bridge 9 into the sample chamber 5 after the capillary bridge 9 has formed, or after it has reached its maximum volume. The degree to which the presence of the fluid medium 6 facilitates the detaching of the liquid from the tested surface 4 can be investigated by the help of this latter solution.

Another advantage of the apparatus according to FIG. 3 and the corresponding method is that the capillary bridge can be formed simply and quickly, the volume of it can be adjusted accurately, therefore it can be easily automated, i.e. allows also have high throughput measurements. A further advantageous property is that, in case the fluid medium is in the liquid phase, then the capillary bridge can be formed easily, in contrast to the arrangement according to FIG. 2, wherein it is more difficult to get through the initial hanging droplet through the air-liquid medium interface. By means of the arrangement according to FIG. 3, in a particularly preferable manner, the measurements “under liquid” can be performed much more simply, making it easier and more accurate to study the displacement-wetting (and de-wetting) and cleaning processes often applied in the field, for which the determination of the liquid-solid adhesion work is relevant.

In the embodiment of the method according to the invention performed by means of the apparatus illustrated in FIG. 3, a measurement element having a capillary conduction channel (see a capillary conduction channel 14 in FIG. 3) opening to the end portion thereof having peripheral circular edge is applied, wherein the end of the capillary conduction channel opposite the end portion having peripheral circular edge is connected to a liquid feeder (see a liquid feeder 12 in FIG. 3), and the cylindrical symmetry-keeping modification is carried out on the cylindrically symmetric capillary bridge by passing the liquid (this is the liquid (adapted) for building the capillary bridge—in other words, the liquid constituting (composing) the capillary bridge—that is expediently also applied for performing a cylindrical symmetry-keeping modification thereon; this will also come up below) through the capillary conduction channel, and the working-related displacement is determined by means of a displacement determination unit adapted for determining the displacement of the liquid in the capillary conduction channel.

Therefore, on the one hand, the manner of performing the cylindrical symmetry-keeping modification in this embodiment is specified above (i.e., a new step is not introduced but the manner of performing is specified); in this case, the cylindrical symmetry-keeping modification is performed solely in this manner, i.e., the measurement element remains stationary, and thus the length of the capillary bridge is also unchanged, while the shape—volume and interfacial areas—of the capillary bridge change. Furthermore, the manner of determining the working-related displacement is also specified.

By passing liquid through the capillary conduction channel the volume of the capillary bridge can be increased (causing the capillary bridge to “become fatter”), while liquid can also be carried away (reducing the volume of the capillary bridge), i.e., also in this case, the two-direction process can be implemented on the capillary bridge—advancing and receding the liquid-solid contact line—which is implemented also by moving the measurement element, as well as the corresponding working-related displacements can be determined.

In accordance with the above, certain embodiments of the invention are related to an apparatus adapted for determining liquid-solid adhesion work. The apparatus according to the invention is suitable for carrying out the method according to the invention, i.e., the apparatus according to the invention is adapted for determining liquid-solid adhesion work by carrying out the method according to the invention.

The apparatus according to the invention comprises
a measurement element having an end portion (with an end portion) having (a) peripheral circular edge for arranging the end portion thereof having a peripheral circular edge in a fluid medium together with a solid object to be tested having a surface to be tested, wherein, in case of utilising (using, usage of) the apparatus, the measurement element and the surface to be tested are arranged with respect to each other such that a liquid cylindrically symmetric capillary bridge can be formed (is formable) between the end portion having (the) peripheral circular edge and the surface to be tested (it was addressed above what kind of the relative arrangement of the components this requires; see also a fluid medium 6, the surface to be tested and a capillary bridge 9 in FIGS. 2 and 3), the measurement element has a capillary conduction channel 14 (this is preferably formed in a capillary tube 11; in FIG. 3 it is shown filled up with a liquid) opening to the end portion having peripheral circular edge.

In some cases, certain components of the apparatus can be defined below in relation to the capillary bridge. On the one hand, this characterization specifies also the cold-state configuration of these components, and on the other hand it is understood in connection with these features that they perform their functions in case of utilising (using of) the apparatus, as it is already specified in the definition above in relation to forming the capillary bridge.

The apparatus further comprises
a liquid feeder (see a liquid feeder 12 in FIG. 3), to which the end of the capillary conduction channel (see a capillary conduction channel 14 in FIG. 3) opposite the end portion having peripheral circular edge is connected (of course the channel has two ends, one of which opens to the end portion having peripheral circular edge, and the other is connected to the liquid feeder, i.e., the liquid feeder is able to feed liquid to or carry away (withdraw) liquid from this end), and
an interfacial area determination arrangement adapted for determining a first interfacial area of the capillary bridge and the fluid medium, and a second interfacial area of the capillary bridge and the surface to be tested,
   wherein the liquid feeder is adapted for (is configured to be adapted for) performing a cylindrical symmetry-keeping modification on the capillary bridge by passing the liquid through the capillary conduction channel.

As it was already mentioned, the liquid feeder is suitable for feeding liquid and for carrying it away, i.e., it is suitable for performing a cylindrical symmetry-keeping modification by passing liquid through the capillary conduction channel. In addition to feeding/removal this also means that it adds or removes liquid corresponding to the cylindrical symmetry-keeping modification such that an advancing or a receding modification is made to the capillary bridge. To determine the displacement value, by means of the liquid feeder it can be expediently determined that how much amount of liquid was fed or removed.

When the apparatus is utilised (is in use), the end portion having peripheral circular edge and the surface to be tested get into a fluid medium—which can even be free air but can also be another appropriately selected fluid—because the liquid-fluid interface also plays a role in determining the liquid-solid adhesion work. The solid object to be tested having the surface to be tested may be replaceable, such that it does not form a part of the apparatus in the out-of-utilisation (out-of-use) state. Moreover, in certain embodiments the circular-shaped end portion of the measurement element can get into the fluid medium applying a movement.

In relation to the interfacial area determination arrangement (surface area determination arrangement) reference is made to FIGS. 2 and 3 that illustrate a light source and a camera (the light source applicable preferably together with the camera—in general, a device adapted for making an optical recording—is typically utilised for providing illumination such that the camera can take images of sufficient contrast and quality), which may preferably form parts of the interfacial area determination arrangement, and with the help of which the camera can transfer such data to an interfacial area determination (computation) unit (this is preferably also part of the interfacial area determination arrangement) with the help of which it is possible to determine a first interfacial area of the capillary bridge and the fluid medium and a second interfacial area of the capillary bridge and the surface to be tested.

The apparatus according to the invention further comprises
a displacement determination unit adapted for determining in the course of the cylindrical symmetry-keeping modification at least one displacement value of the working-related displacement, corresponding to the cylindrical symmetry-keeping modification, of the liquid in the capillary conduction channel,
a force measurer adapted for determining (for determining by measurement) a force value of a capillary force corresponding to the capillary bridge for the at least one displacement value,
an integrator unit adapted for determining a total mechanical work corresponding to the capillary force for the cylindrical symmetry-keeping modification based on the at least one displacement value determined by means of the displacement determination unit in the course of the cylindrical symmetry-keeping modification and the force value assigned respectively thereto, and
a work determination unit adapted for determining, for the cylindrical symmetry-keeping modification
   based on a first interfacial area change and a second interfacial area change of the first interfacial area and the second interfacial area, respectively, determined by the interfacial area determination arrangement between the initial state and the final state of the cylindrically symmetric capillary bridge, on the total mechanical work, and on a liquid-fluid interfacial tension of the capillary bridge and the fluid medium, a first difference value (i.e., the first difference value is determined based on these quantities, see the formulas above) of
      a solid-liquid interfacial tension of the surface to be tested and the (liquid) capillary bridge and
      a solid-fluid interfacial tension of the surface to be tested and the fluid medium, and
   by subtracting the first difference value from the liquid-fluid interfacial tension, a liquid-solid adhesion work corresponding to the cylindrical symmetry-keeping modification and being characteristic of the capillary bridge and the surface to be tested.

The units (displacement determination unit, integrator unit, work determination unit) comprised in the apparatus are essentially computation (calculation) units, and this could also be reflected in their names. An interfacial area determination unit (which at the same time can form a part of the interfacial area determination arrangement described above) can also be included here.

In the apparatus, these units can be parts of a central or main computation unit (their functions (tasks) can be implemented by a single central computation unit, but a plurality of computation units, as well), but each computation unit can also be independent (self-contained), or can be implemented as partially independent with partly common configuration.

The displacement determination unit expediently operates in such a way that it divides the volume change brought about by the liquid feeder (preferably, a known volume is fed out or carried away by the liquid feeder, as well as the volume change can also be determined by analysing the images of the capillary bridge, see above) with the cross sectional area of the capillary conduction channel, thereby determining the displacement (the values of displacement in both directions—resulting in the liquid moving both inward and outward—can be determined in such a way). As it is set forth in the definition above, the integrator unit is adapted for determining the liquid-solid adhesion work based on the appropriate input data.

In accordance with what was described above in connection with the apparatus, in order to determine the total mechanical work, the displacement can be associated with the cylindrical symmetry-keeping modification, it is carried out parallel to the axis of symmetry and is directed at modifying the capillary bridge. As can be seen above, in relation to FIG. 2, the displacement is the change of the length of the capillary bridge caused by the vertical displacement of the measurement element. The displacement can be brought about similarly also in relation to FIG. 3, however in this case the length of the capillary bridge can also be fixed, in which case the displacement of the liquid column (whereby the volume of the capillary bridge is increased or reduced) can be associated with the work done. The displacement in both directions is therefore parallel to the axis of symmetry, and the capillary force also acts in this direction.

Furthermore, in the apparatus according to the invention the force measurer is a weighing scale (scale, balance) having a measuring surface arranged opposite the end portion of the measurement element having peripheral circular edge, wherein the measuring surface is adapted for arranging the solid object to be tested in such a manner that the surface to be tested thereof faces the end portion having peripheral circular edge (see the force measurer implemented as a weighing scale, and the relative arrangement of the weighing scale and the surface 4 to be tested in FIG. 3; in such an arrangement of the force measurer the magnitude of the capillary force can be essentially interpreted as the degree to which the object to be tested is lifted from or pressed against the weighing scale by the capillary force). Force measurers typically measure force correctly if they are arranged in the arrangement shown in the figures, i.e., for example the measuring surface of the weighing scale is horizontal in a manner illustrated in FIG. 3 (and the force measurer shown in FIG. 2 is typically suitable for measuring a vertical-direction force).

If the fluid medium is free air, then the object to be tested is expediently arranged directly on the measuring surface. In case the fluid medium is in a measurement chamber, then the object to be tested is arranged on the measuring surface inside the measurement chamber.

The method according to the invention—as it is suggested by the steps thereof defined above—can be carried out utilising various apparatuses; these apparatuses are required to provide the functionalities introduced above in the description of the method. At the same time, in the apparatus according to the invention there are required such configuration details that ensure that the method can be carried out. Moreover, an important constituent of the common inventive concept of the method and the apparatus according to the invention is that the method according to the invention can be carried out by the apparatus according to the invention.

The apparatus can be preferably configured such that (and the method can be carried out such that, i.e. this variant also falls within the scope of the invention (this variant is also a subject of the invention), i.e. constitutes an embodiment) there is possibility to form a plurality of capillary bridges, preferably arranged side by side (for example in a matrix arrangement), while the respective measurement elements corresponding to each of the capillary bridges are moved together or the volumes of the capillary bridges are changed together via their own capillary channels (i.e., preferably all have the same length). An important feature is that the capillary force is measured collectively for these capillary bridges, so it is typically possible to measure larger forces than in the case of a single capillary bridge.

In this case, the interfacial area determinations are of course performed for all capillary bridges (the interfacial area changes are determined collectively); the interfacial area determination arrangement is suitable to do that.

In the following, measurement results for both the hydrophilic and the hydrophobic case are explained in relation to FIGS. 4A and 4B.

The measurements included below were performed in the arrangement shown in FIG. 2, according to the measurement process described in relation to the figure. The encircled measurement point indicates the formation of the capillary bridge (i.e., that the capillary bridge is established at the encircled location, and the bridge is first compressed and then extended according to the arrows). This is considered the zero point of the displacement scale (range; see the zero point of the displacement axis in FIGS. 4A-4B). Further approximation of the solid surfaces to each other is indicated as a negative displacement. The arrows in FIGS. 4A-4B indicate the direction of the process.

According to the above-mentioned typically applied convention, the sign of the attractive capillary force is positive, i.e., it is considered positive in case it “tries” to pull together the solid surfaces for example [E. J. De Souza et al. Effect of Contact Angle Hysteresis on the Measurement of Capillary Forces. Langmuir 24, p. 1391-1396 (2008)]. Hereinafter we follow this convention.

A typical force-displacement curve measured on a hydrophilic surface (the material of the tested solid surface/surface to be tested is SiO₂) is shown in FIG. 4A. The measurement liquid was ultrapure water with a volume of 1.5 μl. The preferably applicable volume range of the capillary bridge is also affected in the various embodiments by the interfacial tension of the liquid and the fluid medium, and by the difference value of their densities. The measured force and the image of the liquid bridge were recorded every 5 s (i.e., more frequently than what was specified above in relation to FIGS. 2-3).

The capillary force measured in FIG. 4A all the way remains in the positive force domain, i.e., the liquid bridge tries to pull the bounding solid surfaces closer to each other. In the approximating phase (the portion extending from the circle in the direction of the larger negative values) a (negative) mechanical work is performed by the system, which can be calculated by integrating the force-displacement curve recorded in the approximating phase (cf. formula (2)). This work is spent on the (energetically favourable) reduction of the water-air interfacial area (ΔA is negative), and the (also energetically favourable) increasing of the SiO₂-water interfacial area (ΔB is positive).

Higher capillary force values are experienced in the distancing phase (which is the portion extending from the turning in the direction of the positive displacement values as indicated by the corresponding arrow). The reason for this is that detaching water from the SiO₂ surface is harder (more unfavourable energetically) compared to the magnitude of the driving force behind the wetting process (this phenomenon is also manifested in the higher advancing and lower receding contact angles). Due to that, the geometry of the capillary bridge, and thus the dimensions of the interfacial areas (and the changes thereof) are different in the approximating and distancing phases. In the distancing phase, (positive signed) work is performed on the system, in the course of which the water-air interfacial area increases (which is energetically unfavourable; ΔA is positive), and the SiO₂-water interfacial area decreases (which also increases the system's energy; ΔB is negative).

A typical force-displacement curve measured on a hydrophobic (cycloolefin polymer) surface is shown in FIG. 4B. The measurement liquid was ultrapure water with a volume of 1.8 μl, and the measured force values and the image of the liquid bridge were recorded every 5 seconds also in this case (in accordance with the above description, this measurement was also carried out applying an arrangement shown in FIG. 2).

In the approximating phase (also extending from the circle in the direction of larger negative displacement values) the initially positive (contractive) capillary force changes sign, and in the negative force range it tries to move the solid surfaces further from each other. In this range, work is performed on the system, i.e., the value of the integral is positive (both the force and the displacement are negative), so it increases the value of the integral calculated for the entire approximation phase. Likewise, at the start of the distancing phase, work is performed by the system, giving a negative sign contribution in the formula (the force is negative, but the displacement is positive due to the distancing).

The method and the apparatus according to the invention are therefore intended for determining adhesion work being characteristic of a liquid-solid interface (without measuring the contact angle). The apparatus can therefore preferably be operated—and the method can be performed—in such a manner that a cylindrically symmetric capillary bridge is formed from the liquid in the surrounding fluid medium between a circular-shaped solid surface and the tested solid surface, and the contact line adheres (pins) to the edge of the circular-shaped solid surface. The capillary force is measured while changing the length or the volume of the capillary bridge. By processing the image of the capillary bridge, the change of the size of each interfacial area resulting from the change of the length or volume of the capillary bridge is determined. The liquid-solid adhesion work can be calculated from the measured force (by integrating the capillary force over the length change or, essentially, the volume change, of the capillary bridge), from the change of the length or the volume of the capillary bridge, and from the change of the sizes of the interfacial areas provided that the liquid-fluid interfacial tension is known without determining the contact angle of the liquid forming on the tested solid surface. Furthermore, based on the determined adhesion work, the value of the contact angle can be determined without measurement, by calculation (expressing the angle from (1)).

In the following, a differentiation from the prior art approaches referenced in the introduction is provided.

A common feature of the approaches according to JP 2011191277 A, EP 3571483 A1, and JP 2004144573 is that a force related to liquid-solid adhesion is determined but they fail to determine the change of the sizes of the interfacial areas. A common drawback of these approaches stems from this: the solid-liquid adhesion work cannot be determined applying these methods, i.e., the adhesion properties of various solid-liquid material pairs can only be compared by performing measurements with identical parameters, applying the same the arrangements with the given geometry of the particular apparatus.

In contrast to the professional article by N. Nagy, (Contact Angle Determination on Hydrophilic and Superhydrophilic Surfaces by Using r-θ-Type Capillary Bridges. Langmuir 35, p. 5202 (2019))—in which the work done by or on the system and the changes of the interfacial areas are not determined, and the determination of the adhesion work independent from the contact angles is also not disclosed—in the invention the work done by or against the capillary force and the change of the sizes of the interfacial areas are determined on the basis of appropriate measured quantities (preferably by applying an integrator; utilising an integrator like in the approach according to the invention based on integral quantities—in relation to that, see also below—is not included in the professional article), and the liquid-solid adhesion work is also determined, in an extremely preferable manner independent from the contact angles.

According to the invention we have recognised that a method for determining liquid-solid adhesion work can be constructed in an extremely preferable manner that is based on observing the changes of the capillary bridge, and wherein the liquid-solid adhesion work is determined from the quantities measured in the course of it. In the course of the method, the contact angles are not utilised (these are not measured), instead, the work done by or against the capillary force is measured besides the respective interfacial area changes, and the liquid-solid adhesion work is determined based on these measured quantities.

We have therefore come to the recognition that instead of the approach based on instantaneous values (i.e., on contact angles, which would involve uncertainties for determining the work according to the introduction), determining the liquid-solid adhesion work should be based on measuring integral quantity (in a preferable manner, the contact angle can subsequently also be calculated from that, but in this way the adhesion work can be obtained without utilising the value of the contact angle). The approach of the invention based on integral quantities also has the advantage that the integral quantities can typically be measured with greater accuracy because uncertainties and measurement errors (noise) having a zero mean value are integrated out in the course of the process. In sum, therefore, we have recognised that in order to determine the liquid-solid adhesion work, it is necessary to measure another parameter, applying a measurement method that is different from prior art approaches.

To write the above in a slightly different way, it can be said that according to the invention the change is investigated in its process (investigating the balance of the workings done, i.e., establishing what the total mechanical work corresponding to the cylindrical symmetry-keeping change (modification) of the capillary bridge is spent on and how the interfacial areas of the capillary bridge change as a result of it), that is, the measurement points are investigated particularly in the conjunction of each other. Accordingly, we preferably apply an integrator, and take into consideration the changes in relation to the interfacial areas, such as the interfacial area constituted between the capillary bridge and the surrounding fluid and the interfacial area between the capillary bridge and the surface to be tested (in relation to this, reference is made to the description in connection with the investigated section and the rule of thumb applicable there).

In connection with the professional article, it is also noted that—as it is supported by the formulas of the present application (see formula (2) in particular)—the value of the capillary force (which is termed “adhesion force” in the professional article in certain cases) is only partially dependent on the interaction between the liquid and the tested solid surface. Its value is determined also by the size of the interfacial area of the liquid and the tested solid surface, the surface tension of the liquid, and the shape and geometric dimensions of the liquid bridge. As a result of this, the quantity obtained by integrating the capillary force (while the length of the liquid bridge varies) over the length change will not be the liquid-solid adhesion work. The latter cannot be determined without taking into consideration the change of the interfacial areas.

In contrast to the disclosure of U.S. Pat. No. 6,537,499 B1, i.e. to study the adhesion of molecules bound to a surface, in the invention a cylindrical symmetry-keeping modification performed on a liquid capillary bridge is investigated. In connection with the invention, the liquid-solid adhesion work can be determined in both directions, i.e., during the “fattening” and “slimming down” of the capillary bridge (both in the advancing and receding situation), which is different from the quantity according to the document, as, on the one hand, it orders the concept of adhesion work to the difference between the contributions coming from the movements in both directions, and, on the other hand, between the two processes the column downward pressing the molecules is subjected to elastic deformation, i.e. the two mutually facing solid surfaces are forcefully pressed against each other. The latter is expressly contrary to the method according to the invention, wherein pressing mutually facing measurement surfaces against each other is particularly to be avoided (in the invention, either an advancing or a receding situation is investigated; in addition to compression, the turn from the advancing to the receding situation is also avoided in the method according to the invention, the integration is typically not performed for it, cf. the description of the rule of thumb above).

In the invention, therefore, the adhesion work is solid-liquid adhesion work, which can be determined only in the knowledge of the mechanical work done in the course of a cylindrical symmetry-keeping modification of the capillary bridge, the liquid-solid interfacial tension and the change of the sizes of the interfacial areas. Therefore, U.S. Pat. No. 6,537,499 B1 does not disclose such a method for determining liquid-solid adhesion work that is analogous to the invention.

In the case of JP 2013174478 A and CA 2968623 mentioned in the introduction, the volume change of the capillary bridge is not investigated beside a capillary-type liquid introduction (the introduction of a concrete—constant—amount of liquid is mentioned), and the liquid-solid adhesion work is not determined in accordance with the steps of the invention, based on the change of the interfacial areas.

The formula (1) for determining liquid-solid adhesion work based on measuring the contact angle discussed in the introduction is also referenced in other documents referred to hereinabove as the part of the prior art (see the above-mentioned CA 2968623). The invention eliminates the drawbacks (theoretical and measurement uncertainties) related to calculations based on measuring the contact angle, giving a solution—i.e., a direct method—for determining the liquid-solid adhesion work independent of measuring the contact angles.

In summary, the method and apparatus according to the invention have the advantage that the liquid-solid adhesion work is determined on the basis of force measurement, without knowing the contact angle of the liquid forming at the tested solid surface. A further advantage is that it is sufficient to utilise liquid amounts of very small volume, and that the measurements can be performed in a sample chamber, i.e., the fluid medium can be chosen. Therefore, the measurements can be carried out in a near-saturated (close-to-saturated) vapour space of the liquid, or in another, immiscible liquid medium.

For characterising the invention, the points below defining further embodiments are set forth. Paragraph 1 below is to be taken to include further features of the invention not mentioned therein, while certain features given in Paragraph 1 can be made to correspond to certain features of the invention, and optional features also appear. Further subpoints add other optional features to the embodiments according to the cross-references between the paragraphs.

1. An apparatus for determining solid-liquid adhesion work without contact angle measuring, having a circular-shaped solid surface 1, a force measurer 2, a linear mover 3, a tested solid surface 4, at least one light source 7, at least one camera 8, at least one capillary bridge 9, at least one integrator unit 10, wherein a capillary force measured by the force measurer 2 is integrated over a length change of the capillary bridge 9 by the integrator unit 10, and sizes of interfacial areas of the capillary bridge 9 are calculated by the integrator unit 10 based on an image of the camera 8.

2. An apparatus for determining solid-liquid adhesion work without contact angle measuring, comprising a circular-shaped solid surface 1 forming the base plate of a capillary tube 11, a force measurer 2, a linear mover 3, a tested solid surface 4, at least one light source 7, at least one camera 8, at least one capillary bridge 9, at least one integrator unit 10, and at least one liquid feeder 12 (optionally, the apparatus consists of these), wherein a capillary force measured by the force measurer 2 is integrated over a volume change of the capillary bridge 9 by the integrator unit 10, and sizes of interfacial areas of the capillary bridge 9 are calculated by the integrator unit 10 based on an image of the camera 8.

3. The apparatus according to point 1 or point 2, wherein the material of the circular-shaped solid surface 1 is glass.

4. The apparatus according to point 1 or point 2, wherein the material of the circular-shaped solid surface 1 is platinum.

5. The apparatus according to point 1 or point 2, wherein the meniscus of the liquid adheres (pins) on the edge of the circular-shaped solid surface 1.

6. The apparatus according to point 1 or point 2, wherein the circular-shaped solid surface 1, the tested solid surface 4, and the capillary bridge 9 are arranged in a common sample chamber 5.

7. The apparatus according to point 6, wherein the fluid medium 6 filling the sample chamber 5 is the near-saturated vapour space of the liquid.

8. The apparatus according to point 6, wherein the fluid medium 6 forming the environment of the capillary bridge 9 in the sample chamber 5 is a liquid-state medium immiscible with the liquid.

9. A method for determining liquid-solid adhesion work, based on changing a length of a cylindrically symmetric capillary bridge 9 formed in a fluid medium 6 from liquid between a circular-shaped solid surface 1 and a tested solid surface 4, and on measuring the capillary force, wherein the length of the capillary bridge 9 is changed, in the course of which the capillary force and the change of the length of the capillary bridge 9 are measured, a change of the size of the liquid-fluid interfacial area and a change of the size of the interfacial area between the liquid and the tested solid surface 4 is determined, and based on these the liquid-solid adhesion work is calculated.

10. A method for determining liquid-solid adhesion work, based on measuring a capillary force a cylindrically symmetric capillary bridge 9 formed in a fluid medium 6 from liquid between a circular-shaped solid surface 1 and the tested solid surface 4, wherein the volume of the capillary bridge 9 is changed, in the course of which the capillary force and the change of the volume of the capillary bridge 9 are measured, and a change of the size of the liquid-fluid interfacial area and a change of the interfacial area between the liquid and the tested solid surface 4 are determined, and based on these the liquid-solid adhesion work is calculated.

11. The method according to point 9 or point 10, wherein the material of the circular-shaped solid surface 1 is glass.

12. The method according to point 9 or point 10, wherein the material of the circular-shaped solid surface 1 is platinum.

13. The method according to point 9 or point 10, wherein the meniscus of the liquid adheres (pins) on the edge of the circular-shaped solid surface 1.

14. The method according to point 9 or point 10, wherein a contact angle developed at the phase boundary of the liquid, the fluid medium 6 and the tested solid surface 4 is calculated from the liquid-solid adhesion work.

15. The method according to point 9 or point 10, wherein the size of the interfacial area between the liquid and the fluid medium 6, and the size of the interfacial area between the liquid and the tested solid surface 4 are determined based on processing the image of the capillary bridge 9.

16. The method according to point 10, wherein the volume of the capillary bridge 9 is calculated based on processing the image of the capillary bridge 9.

17. The method according to point 9 or point 10, wherein the circular-shaped solid surface 1, the tested solid surface 4, and the capillary bridge 9 are arranged in a common sample chamber 5.

18. The method according to point 17, wherein the fluid medium 6 filling the sample chamber 5 is the near-saturated vapour space of the liquid.

19. The method according to point 17, wherein the fluid medium 6 forming the environment of the capillary bridge 9 in the sample chamber 5 is a liquid-state medium immiscible with the liquid.

20. The method according to point 19, wherein the liquid-state fluid medium 6 immiscible with the liquid is filled into the sample chamber 5 after the capillary bridge 9 is formed.

21. The method according to point 19, wherein the liquid-state fluid medium 6 immiscible with the liquid is filled into the sample chamber 5 in such a state of the capillary bridge 9 wherein it is the shortest or has the largest volume.

The invention is, of course, not limited to the preferred embodiments described in detail above, but further variants, modifications and developments are possible within the scope of protection determined by the claims.

1. A method for determining liquid-solid adhesion work, in the course of which, in connection with a liquid cylindrically symmetric capillary bridge (9) formed in a fluid medium (6) between an end portion having peripheral circular edge of a measurement element and a surface (4) to be tested of a solid object to be tested, the following steps are performed:
by performing a cylindrical symmetry-keeping modification on the cylindrically symmetric capillary bridge (9), starting from an initial state and ending in a final state,
determining (S110a) between the initial state and the end state a first interfacial area change of a first interfacial area of the capillary bridge (9) and the fluid medium (6), and a second interfacial area change of a second interfacial area of the capillary bridge (9) and the surface (4) to be tested, and
by determining (S100) in the course of the cylindrical symmetry-keeping modification at least one displacement value of the working-related displacement corresponding to the cylindrical symmetry-keeping modification and respective force value of the capillary force corresponding to the capillary bridge (9) therefor, determining (S110b), based on the at least one displacement value determined in the course of the cylindrical symmetry-keeping modification and the force value assigned respectively thereto, a total mechanical work corresponding to the capillary force for the cylindrical symmetry-keeping modification,
determining (S120), for the cylindrical symmetry-keeping modification, based on the first interfacial area change, the second interfacial area change, the total mechanical work, and a liquid-fluid interfacial tension of the capillary bridge (9) and the fluid medium (6), a first difference value of
a solid-liquid interfacial tension of the surface (4) to be tested and the capillary bridge (9), and
a solid-fluid interfacial tension of the surface (4) to be tested and the fluid medium (6), and
by subtracting the first difference value from the liquid-fluid interfacial tension, determining (S130) a liquid-solid adhesion work corresponding to the cylindrical symmetry-keeping modification and being characteristic of the capillary bridge (9) and the surface (4) to be tested.

2. The method according to claim 1, characterised by calculating the first difference value according to
$${γ}_{SL} - {γ}_{SF} = \frac{\int F dz - Δ A \cdot {γ}_{LF}}{Δ B}$$
formula, wherein
γ_{SL} is the solid-liquid interfacial tension, and γ_{SF} is the solid-fluid interfacial tension,
∫F dz is the total mechanical work,
γ_{LF} is the liquid-fluid interfacial tension, and
ΔA is the first interfacial area change, and ΔB is the second interfacial area change.

3. The method according to claim 1, characterised in that a measurement element having a capillary conduction channel (14) opening to the end portion thereof having peripheral circular edge is applied, wherein the end of the capillary conduction channel (14) opposite the end portion having peripheral circular edge is connected to a liquid feeder (12), and the cylindrical symmetry-keeping modification is carried out on the cylindrically symmetric capillary bridge (9) by passing the liquid through the capillary conduction channel (14), and the working-related displacement is determined by means of a displacement determination unit adapted for determining the displacement of the liquid in the capillary conduction channel (14).

4. An apparatus for determining liquid-solid adhesion work, comprising
a measurement element having an end portion having peripheral circular edge for arranging the end portion thereof having peripheral circular edge in a fluid medium (6) together with a solid object to be tested having a surface (4) to be tested, wherein, in case of utilising the apparatus, the measurement element and the surface (4) to be tested are arranged with respect to each other such that a liquid cylindrically symmetric capillary bridge (9) can be formed between the end portion having peripheral circular edge and the surface (4) to be tested, the measurement element has a capillary conduction channel (14) opening to the end portion having peripheral circular edge,
a liquid feeder (12), to which the end of the capillary conduction channel (14) opposite the end portion having peripheral circular edge is connected, and
an interfacial area determination arrangement adapted for determining a first interfacial area of the capillary bridge (9) and the fluid medium (6), and a second interfacial area of the capillary bridge (9) and the surface (4) to be tested,
characterised in that the liquid feeder (12) is adapted for performing a cylindrical symmetry-keeping modification on the cylindrically symmetric capillary bridge (9) by passing the liquid through the capillary conduction channel (14), the apparatus further comprising
a displacement determination unit adapted for determining in the course of the cylindrical symmetry-keeping modification at least one displacement value of the working-related displacement, corresponding to the cylindrical symmetry-keeping modification, of the liquid in the capillary conduction channel (14),
a force measurer (2) adapted for determining a force value of a capillary force corresponding to the capillary bridge (9) for the at least one displacement value,
an integrator unit (10) adapted for determining a total mechanical work corresponding to the capillary force for the cylindrical symmetry-keeping modification based on the at least one displacement value determined by means of the displacement determination unit in the course of the cylindrical symmetry-keeping modification and the force value assigned respectively thereto, and
a work determination unit adapted for determining, for the cylindrical symmetry-keeping modification,
based on a first interfacial area change and a second interfacial area change of the first interfacial area and the second interfacial area, respectively, determined by the interfacial area determination arrangement between the initial state and the final state of the cylindrically symmetric capillary bridge (9), on the total mechanical work, and on a liquid-fluid interfacial tension of the capillary bridge (9) and the fluid medium (6), a first difference value of
a solid-liquid interfacial tension of the surface (4) to be tested and the capillary bridge (9) and
a solid-fluid interfacial tension of the surface (4) to be tested and the fluid medium (6), and
by subtracting the first difference value from the liquid-fluid interfacial tension, a liquid-solid adhesion work corresponding to the cylindrical symmetry-keeping modification and being characteristic of the capillary bridge (9) and the surface (4) to be tested.

5. The apparatus according to claim 4, characterised in that the first difference value is calculated according to
$${γ}_{SL} - {γ}_{SF} = \frac{\int F dz - Δ A \cdot {γ}_{LF}}{Δ B}$$
formula, wherein
γ_{SL} is the solid-liquid interfacial tension, and γ_{SF} is the solid-fluid interfacial tension,
∫F dz is the total mechanical work,
γ_{LF} is the liquid-fluid interfacial tension, and
ΔA is the first interfacial area change, and ΔB is the second interfacial area change.

6. The apparatus according to claim 4, characterised in that the force measurer (2) is a weighing scale having a measuring surface arranged opposite the end portion of the measurement element having peripheral circular edge, wherein the measuring surface is adapted for arranging the solid object to be tested in such a manner that the surface (4) to be tested thereof faces the end portion having peripheral circular edge.

7. The apparatus according to claim 5, characterised in that the force measurer (2) is a weighing scale having a measuring surface arranged opposite the end portion of the measurement element having peripheral circular edge, wherein the measuring surface is adapted for arranging the solid object to be tested in such a manner that the surface (4) to be tested thereof faces the end portion having peripheral circular edge.

8. The method according to claim 2, characterised in that a measurement element having a capillary conduction channel (14) opening to the end portion thereof having peripheral circular edge is applied, wherein the end of the capillary conduction channel (14) opposite the end portion having peripheral circular edge is connected to a liquid feeder (12), and the cylindrical symmetry-keeping modification is carried out on the cylindrically symmetric capillary bridge (9) by passing the liquid through the capillary conduction channel (14), and the working-related displacement is determined by means of a displacement determination unit adapted for determining the displacement of the liquid in the capillary conduction channel (14).
